(19) United States
(12) Patent Application Publication
(10) Pub. No.: US 2022/0036011 A1
(43) Pub. Date: Feb. 3, 2022

(54) Systems and Methods for Explainable Fake News Detection

(71) Applicant: InfoAuthN AI Inc., Murphy, TX (US)

(72) Inventor: Kai Shu, Chicago, IL (US)

(21) Appl. No.: 17/384,271

(22) Filed: Jul. 23, 2021

Related U.S. Application Data
(60) Provisional application No. 63/058,485, filed on Jul. 30, 2020.

(51) Int. Cl. G06F 40/30; G06F 16/2457; G06N 3/08

(52) U.S. Cl. CPC G06F 40/30; G06N 3/08; G06F 16/24578

(57) ABSTRACT

A news article may include sentences and have associated comments. A embodiment determines semantic correlation between each sentence and each comment to generate correlation degrees between the sentences and the comments, determines sentence attention weights of the sentences and comment attention weights of the comments based on the correlation degrees, and detect whether the news article is fake based on latent representations of the sentences and the comments, the sentence attention weights and the comment attention weights. A list of sentences and a list of comments may be selected based on the sentence attention weights and the comment attention weights, respectively, to provide explanation for a detection result.

### CROSS-REFERENCE TO RELATED APPLICATIONS

This application claims the benefit of U.S. Provisional Application No. 63/058,485, filed on Jul. 29, 2020, which application is hereby incorporated herein by reference in its entirety.

### TECHNICAL FIELD

The present disclosure relates generally to new processing, and, in particular embodiments, to a system and method for explainable fake news detection.

### BACKGROUND

The use of Internet has greatly facilitated the creation and spreading of information including news and access to information. As an example, social media platforms provide convenient conduit for users to create, access, and share diverse information. Due to the increased usage and convenience of social media, more people seek out and receive timely news information online. The Pew Research Center announced that approximately 68% of US adults get news from social media in 2018, while only 49% reported seeing news on social media in 2012. However, at the same time, social media enables users to get exposed to misinformation and disinformation, including fake news. Widespread of fake news has detrimental societal effects. It is desirable to develop mechanisms for detecting fake news.

### SUMMARY

Technical advantages are generally achieved, by embodiments of this disclosure which describe systems and methods for explainable fake news detection.

According to one aspect of the present disclosure, a method is provided that includes: obtaining a piece of news comprising a plurality of sentences; obtaining a plurality of comments associated with the piece of news; determining semantic correlation between each sentence of the plurality of sentences and each comment of the plurality of comments based on latent representations of the plurality of sentences and latent representations of the plurality of comments, to generate respective correlation degrees between the plurality of sentences and the plurality of comments; determining a sentence attention weight of each sentence of the plurality of sentences and a comment attention weight of each comment of the plurality of comments, based on the respective correlation degrees, the latent representations of the plurality of sentences and the latent representations of the plurality of comments; and detecting whether the piece of news is fake based on the latent representations of the plurality of sentences weighted by respective sentence attention weights and based on the latent representations of the plurality of comments weighted by respective comment attention weights.

Optionally, in any of the preceding aspects, the method further includes generating a detection result indicating whether the piece of news is fake, the detection result comprising a list of sentences selected from the plurality of sentences and comprising a list of comments selected from the plurality of comments, wherein each sentence of the list of sentences has a sentence attention weight greater than a sentence threshold, and each comment of the list of comments has a comment attention weight greater than a comment threshold.

Optionally, in any of the preceding aspects, the detection result further indicates a correspondence between a sentence of the list of sentences and a comment of the list of comments, the comment comprising an explanation feature corresponding to the sentence.

Optionally, in any of the preceding aspects, the method further includes: ranking the list of sentences on a degree of explainability for detecting whether the piece of news is fake; and ranking the list of comments on a degree of explainability for detecting whether the piece of news is fake.

Optionally, in any of the preceding aspects, the method further includes: sorting the plurality of sentences in a descending order of the respective sentence attention weights; and sorting the plurality of comments in a descending order of the respective comment attention weights; selecting top-k1 sentences from the plurality of sentences as the list of sentences; and selecting top-k2 comments from the plurality of comments as the list of comments, wherein k1 and k2 are integers greater than 0.

Optionally, in any of the preceding aspects, the method further includes generating the latent representations of the plurality of sentences and the latent representations of the plurality of comments, respectively, using a recurrent neural network based word encoder with bidirectional gated recurrent units (GRUs).

Optionally, in any of the preceding aspects, the correlation degrees are calculated as: F=tan h(C^{T}WₗS), wherein F is an affinity matrix with each matrix element representing a correlation degree, C represent the latent representations of the plurality of sentences, S represent the latent representations of the plurality of comments, Wₗ∈ [symbol] ^{2d×2d} is a weight matrix, C^{T} represent transpose of C, tan h ( ) represents the hyperbolic tangent function.

Optionally, in any of the preceding aspects, the respective sentence attention weights and the respective comment attention weights are calculated as:

$${a}^{s} = softmax ( {w}_{h s}^{T} {H}^{s} )$$

$${a}^{c} = softmax ( {w}_{h c}^{T} {H}^{c} ) ,$$

wherein a^{s}∈ [symbol] ^{1×N} represents the respective sentence attention weights and a^{c}∈ [symbol] ^{1×T} represents the respective comment attention weights, N is an integer representing a quantity of the plurality of sentences, T is an integer representing a quantity of the plurality of comments, wₕₛ, w_{hc}∈ [symbol] ^{1×k} are weight parameters, softmax ( ) is the softmax function, and

$${H}^{s} = tanh ( {W}_{s} S + ( {W}_{c} C ) F ) \\ {H}^{c} = tanh ( {W}_{c} C + ( {W}_{s} S ) {F}^{T} ) ,$$

wherein Wₛ, W_{c}∈ [symbol] ^{k×2d} are weight parameters.

Optionally, in any of the preceding aspects, the method is performed using a learning neural network, and the method further includes training the learning neural network using a detection result of detecting whether the piece of news is fake.

According to another aspect of the present disclosure, a device is provided that includes a non-transitory memory storage comprising instructions; and one or more processors in communication with the memory storage, wherein the instructions, when executed by the one or more processors, cause the device to perform the method in any of the preceding aspects.

According to another aspect of the present disclosure, a non-transitory computer-readable media is provided. The non-transitory computer-readable media stores computer instructions that when executed by one or more processors of a device, cause the device to perform the in any of the preceding aspects.

Aspects of the present disclosure jointly explore news contents and user comments to capture explainable features for fake news detection, which enables to improve performance and explainability of fake news detection.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram illustrating an embodiment explainable fake news detection framework;

FIG. 2 is a diagram illustrating another embodiment explainable fake news detection framework, highlighting details in each component of the framework;

FIG. 3 is a diagram illustrating an embodiment explainable fake news detection result;

FIGS. 4A and 4B are graphs showing performances of various explainable fake news detection methods;

FIGS. 5A-5D are graphs showing performance of different methods in determining top-ranked explainable sentences;

FIG. 6 is a diagram of an embodiment method for explainable fake news detection; and

FIG. 7 is a block diagram of a processing system that may be used for implementing the embodiment methods.

### DETAILED DESCRIPTION OF ILLUSTRATIVE EMBODIMENTS

Fake news detection is attracting growing attention in recent years. It is desirable that a fake news mechanism can not only determine whether a news article is fake, but also can provide explanation of why the news article is fake. Embodiments of the present disclosure provide systems and methods for explainable fake news detection by exploring explainable information jointly from news contents and user comments. For a news article including sentences and having associated comments, an embodiment method determines semantic correlation between each sentence and each comment to generate correlation degrees between the sentences and the comments, determines respective sentence attention weights of the sentences and comment attention weights of the comments based on the correlation degrees, and detects whether the news article is fake based on latent representations of the sentences and the comments, the sentence attention weights and the comment attention weights. A list of sentences and a list of comments may be selected based on the sentence attention weights and the comment attention weights, respectively, to provide explanation for a fake news detection result of the news article.

Online platforms, such as social media platforms, provide convenient and fast channels for news sharing and accessing. However, they also make users exposed to a myriad of misinformation and disinformation, including fake news, which include news stories with intentionally false information. For example, a report estimated that over 1 million tweets were related to a fake news story “Pizzagate” by the end of the 2016 presidential election.

Widespread fake news may cause detrimental societal effects. First, it may significantly weaken the public trust in governments and journalism. For example, the reach of fake news during the 2016 U.S. presidential election campaign for top-20 fake news pieces was, ironically, larger than the top-20 most-discussed true stories. Second, fake news may change the way people respond to legitimate news. A study has shown that people's trust in mass media has dramatically degraded across different age groups and political parties. Third, rampant “online” fake news can lead to “offline” societal events. For example, fake news claiming that Barack Obama was injured in an explosion wiped out $130 billion in stock value. Therefore, it has become critically important to be able to curtail the spread of fake news on social media, promoting trust in the entire news ecosystem.

However, detecting online fake news, e.g., news on social media, presents unique challenges. First, as fake news is intentionally written to mislead readers, it is non-trivial to detect fake news simply based on its content. Second, social media data is large-scale, multi-modal, mostly user-generated, and sometimes anonymous and noisy. To address these challenges, recent research advancements aggregate users' social engagements on news pieces to help infer which articles are fake, giving some promising early results. For example, a hybrid deep learning framework is proposed to model news texts, user response, and post source simultaneously for fake news detection. As another example, a hierarchical neural network is used to detect fake news, by modeling user engagements with social attention that selects important user comments.

The existing methods, however, mainly focus on detecting fake news effectively with latent features, but do not explain “why” a piece of news was detected as fake news. Being able to explain why news is determined as fake is desirable. The derived explanation may provide new insights and knowledge originally hidden to practitioners. Extracting explainable features from noisy auxiliary information can further help improve fake news detection performance.

Embodiments of the present disclosure provide a mechanism for computationally detecting fake news with proper explanation. In some embodiments, explanation may be derived from the perspectives of news contents and user comments associated with the news. The news contents may include information that is verifiably false, and may be used to determine whether the news is fake. For example, journalists may manually check claims (news contents) in news articles on fact-checking websites such as PolitiFact. This is usually labor-intensive and time-consuming. Researchers may attempt to use external sources to fact-check the claims in news articles to decide and explain whether a news piece is fake or not. This may not be able to check newly emerging events (that has not been fact-checked). User comments may have rich information from the crowd on social media, including opinions, stances, and sentiment, that are useful to detect fake news. For example, researchers have proposed to use social features to select important comments to predict fake news pieces. News contents and user comments may inherently be related to each other and provide important cues to explain why a given news article is fake or not. For example, a user comment may directly respond to a claim in a news article, and thus may be used to determine whether the claim in the news article.

In some embodiments, the problem of fake news detection is addressed by jointly exploring explainable information from news contents and user comments. An embodiment explainable fake news detection framework named as dEFEND (Explainable FakE News Detection) is provided, which involves a coherent process and includes: (1) a component to encode news contents (to learn news sentence representations through a hierarchical attention neural network to capture the semantic and syntactic cues), (2) a component to encode user comments (to learn latent representations of user comments through a word-level attention sub-network), and (3) a sentence-comment co-attention component (to capture the correlation between news contents and comments and to select top-k explainable sentences and comments). The embodiments provide explainable comments and check-worthy news sentences simultaneously, and improve fake news detection performance.

The embodiments address the following challenges: (1) perform explainable fake news detection that can improve detection performance and explainability simultaneously; (2) extract explainable comments without the ground truth during training; and (3) model the correlation between news contents and user comments jointly for explainable fake news detection.

An embodiment solution is related to explainable machine learning. The conventional explainable machine learning can generally be grouped into two categories: intrinsic explainability and post-hoc explainability. Intrinsic explainability is achieved by constructing self-explanatory models which incorporate explainability directly into their structures. The explainability is achieved by finding features with large coefficients that play key roles in interpreting the predictions. However, these models are often ineffective in modeling complex real-world data. The post-hoc explainability requires creating a second model to provide explanation for an existing model. The embodiment solution utilizes a co-attention mechanism to jointly capture the intrinsic explainability of news sentences and user comments and improve fake news detection performance.

A problem of explainable fake news detection for the embodiments of the present disclosure is stated as follows. Let A be a news article consisting of N sentences {sᵢ}ᵢ₌₁^{N}. Each sentence sᵢ={w₁ⁱ, . . . , w_{M}_{ᵢ}ⁱ} contains Mᵢ words. Let [symbol] ={c₁, c₂, . . . , c_{T}} be a set of T comments related to (or associated with) the news article A, where each comment cⱼ={w₁^{j}, . . . , w_{Q}_{ⱼ}^{j}} contains Qⱼ words. The fake news detection problem may be treated as a binary classification problem, i.e., each news article can be true (y=1) or fake (y=0). At the same time, a rank list RS of all sentences in {sᵢ}ᵢ₌₁^{N}, and a rank list RC of all comments in {cⱼ}ⱼ₌₁^{T}, may be learned according to a degree of explainability, where RSₖ denotes the kₜₕ most explainable sentence, and RCₖ denotes the kₜₕ most explainable comment. The explainability of the sentences in the news article represents the degree of how check-worthy the sentences are. The explainability of the comments denote the degree of how much users believe that the news article is fake or real, closely related to the major claims in the news article. The problem of explainable fake news detection may be stated as:
Given a news article A and a set of related comments C, learn a fake news detection function ƒ:ƒ(A, C)→(ŷ, RS, RC), such that it maximizes prediction accuracy with explainable sentences and comments ranked highest in RS and RC respectively.

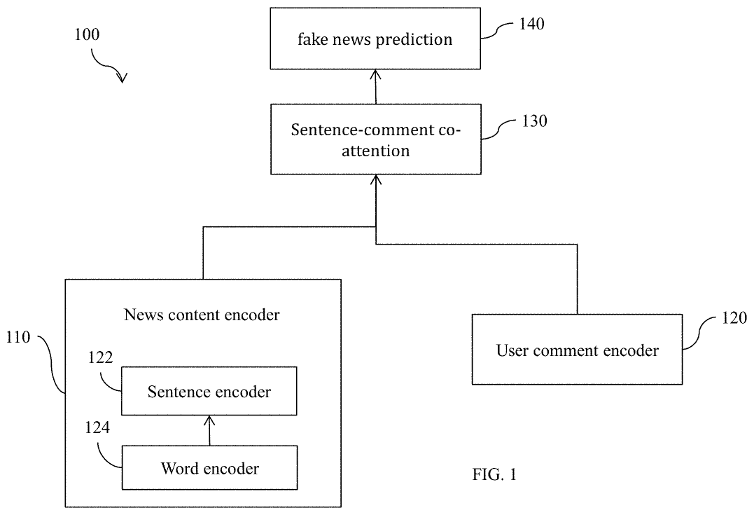

The embodiments in the following will be described based on the explainable fake news detection problem stated above and using the same denotations as above. FIG. 1 is a diagram illustrating an embodiment explainable fake news detection framework 100, which is named dEFEND in the present disclosure. The framework 100 includes a news content encoder 110 (including a word encoder 112 and a sentence encoder 114) component, a user comment encoder component 120, a sentence-comment co-attention component 130, and a fake news prediction component 140.

The news content encoder 110 describes the modeling of the news content (news sentences) from the news linguistic features to latent feature space through a hierarchical word-level and sentence-level encoding. The news content encoder 110 is configured to generate sentence representations of the sentences comprised in the news article. The word encoder 112 is configured to generate sentence vectors of the sentences. The sentence encoder 114 is configured to generate the sentence representations based on the sentence vectors generated by the word encoder 112. The user comment encoder 120 illustrates the comment latent feature extraction of user comments through word-level attention networks. The user comment encoder 120 is configured to generate comment representations of comments associated with the news article. The sentence-comment co-attention component 130 is configured to model, based on the sentence representations generated from the news content encoder 110 and the comment representations generated from the user comment encoder 120, the mutual influences between the news sentences and the user comments for learning feature representations, and generate attention weights for each of the sentences and comments. The explainability degree of the news sentences and the user comments may be learned through the attention weights within co-attention learning. The fake news prediction component 140 is configured to process the news content and the user comments based on the attention weights of the sentences and comments, the sentences and the comments. The fake news prediction component 140 may include a process of concatenating news content and user comment features for fake news classification.

As fake news pieces are intentionally created to spread inaccurate information rather than to report objective claims, they often have opinionated and sensational language styles, which have the potential to help detect fake news. In addition, a news document may include linguistic cues with different levels such as word-level and sentence-level, which may provide different degrees of importance for the explainability of why the news is fake. For example, in a fake news claim “Pence: Michelle Obama is the most vulgar first lady we've ever had”, the word “vulgar” contributes more signals to decide whether the news claim is fake rather than other words in the sentence.

Recently, researchers have found that hierarchical attention neural networks are very practical and useful to learn document representations with highlighting important words or sentences for classification. A hierarchical neural network may be adopted to model word-level and sentence-level representations through self-attention mechanisms. In some embodiments, news content representations may be learned through a hierarchical structure. Specifically, as an example, sentence vectors may be learned by using the word encoder with attention, and sentence representations may then be learned through the sentence encoder component.

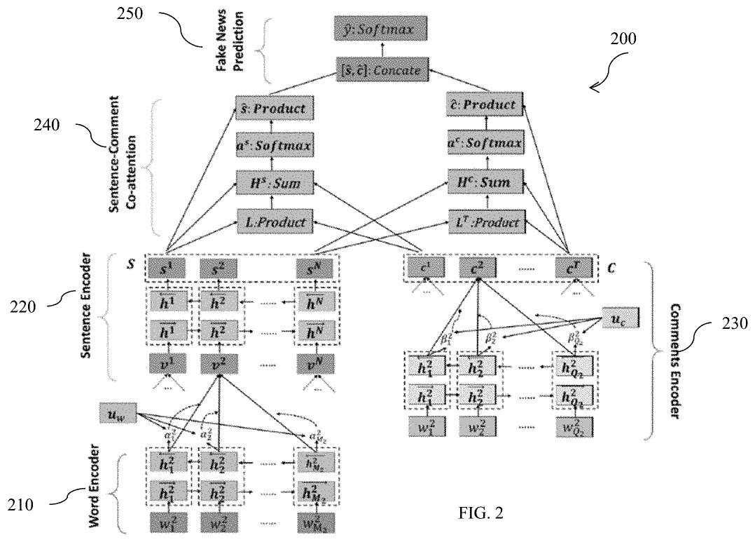

FIG. 2 is a diagram illustrating another embodiment explainable fake news detection framework 200, highlighting details in each component of the framework 200. FIG. 2 illustrates an embodiment implementation of the framework 100. As shown, the framework 200 includes a word encoder 210, a sentence encoder 220, a comment encoder 230, a sentence-comment co-attention component 240, and a fake news prediction component 250.

In some embodiments, the word encoder 210 may be a recurrent neural network (RNN) based word encoder, which is used to learn sentence representations of news sentences. Though in theory, RNN is able to capture long-term dependency, in practice, the old memory will fade away as the sequence becomes longer. To making it easier for RNNs to capture long-term dependencies, gated recurrent units (GRUs) may be used to provide a more persistent memory. GRUs may be adopted to encode word sequences. To further capture the contextual information of annotations, bidirectional GRUs may be used to model word sequences from both directions of words. The bidirectional GRUs include a forward GRU \vec{ƒ} which reads sentence sᵢ from word w₁ⁱ to w_{M}_{ᵢ}ⁱ and a backward GRU [symbol] which reads sentence sᵢ from word w_{M}_{ᵢ}ⁱ to w₁ⁱ. A forward hidden state hidden state \vec{hₜ^{l}} and a backward hidden state [symbol] of word w_{c}ⁱ in sentence sᵢ may be obtained as:

\vec{hₜⁱ}=\vec{GRU}(wₜⁱ),t∈{1, . . . ,Mᵢ}

[symbol]

= [symbol] (wₜⁱ),t∈{Mᵢ, . . . ,1}. (1)

An annotation hₜⁱ of word wₜⁱ may then be obtained by concatenating the forward hidden state \vec{hₜⁱ} and hidden state hidden state [symbol] , i.e., hₜⁱ=[\vec{hₜⁱ}], [symbol] ,∈{1, . . . , Mᵢ}, which includes the information of the whole sentence centered around wₜⁱ. hₜⁱ may also be referred to as a hidden state of word wₜⁱ.

Note that not all words may contribute equally to representation of the sentence meaning. Therefore, an attention mechanism is introduced to learn weights of words in a sentence, to measure the importance of each word to the sentence. Each word may be associated with a weight, and the weight represents semantic contribution of the word to the meaning of the sentence. A sentence vector vⁱ∈ [symbol] ^{2d×1} for sentence sᵢ may be computed as follows:

vⁱ=Σₜ₌₁^{M}^{ᵢ}αₜⁱhₜⁱ, (2)

where at measures the importance of the t^{th} word for the sentence sᵢ, and αₜⁱ may be calculated as follows:

$${u}_{t}^{i} = tanh ( {W}_{w} {h}_{t}^{i} + {b}_{w} ) \\ {α}_{t}^{i} = \frac{exp ( {u}_{t}^{i} {u}_{w}^{T} )}{{\sum }_{k = 1}^{{M}_{i}} exp ( {u}_{k}^{i} {u}_{w}^{T} )} , \qquad ( 3 )$$

where uₜⁱ is a hidden representation of hₜⁱ, which may be obtained by feeding the hidden state hₜⁱ to a fully embedding layer (e.g., with non-linear activation function tan h), and u_{W} is the weight parameter that represents a word-level context vector. uₘ may be obtained based on semantic information of each word in the sentence. αₜⁱ may also be referred to as an attention weight of the word wₜⁱ, and indicates a level of importance of the word wₜⁱ to the meaning of the sentence sᵢ.

A sentence vector v for each sentence sᵢ may thus be obtained using equations (1)-(3). FIG. 2 shows an example using sentence s₂ of N sentences of the news article. As shown, the forward hidden state \vec{hₜ²} and the backward hidden state [symbol] of each word wₜ², t∈{1, . . . , Mᵢ} are obtained based on equation (1). Based on equations (2) and (3), a sentence vector v² is then obtained for the sentence s₂.

Similar to the word encoder 210, RNNs with GRU units may be used to encode each sentence in news articles at the sentence encoder 220. The sentence encoder 220 may be configured to capture the context information in the sentence-level to learn a sentence representations hⁱ from the learned sentence vector vⁱ of sentence sᵢ. In some embodiments, the N sentences of the news article may be encoded using a bidirectional GRU. A forward hidden state \vec{h^{t}} and a backward hidden state [symbol] of sentence sᵢ may be obtained as follows:

\vec{hⁱ}=\vec{GRU}(vⁱ),i∈{1, . . . ,N}

[symbol]

= [symbol] (vⁱ),i∈{N, . . . ,1}. (4)

For each sentence sᵢ, a sentence annotation sⁱ∈ [symbol] ^{2d×1} may be obtained by concatenating the forward hidden state \vec{hⁱ} and the backward hidden state [symbol] i.e., sⁱ=[\vec{h^{t}}, [symbol] ], which captures the context from neighbor sentences around sentence sᵢ. sⁱ may also be referred to as a latent representation or latent feature of sentence sᵢ.

As FIG. 2 shows, each sentence vector vⁱ, i∈{1, . . . , N}, is used to generate a forward hidden state \vec{hᵢ} and a backward hidden state [symbol] of sentence sᵢ based on equation (4). Then a sentence annotation sⁱ=[\vec{hⁱ}, [symbol] ] for each sentence sᵢ is generated based on the forward hidden state h and a backward hidden state [symbol] .

People may express their emotions or opinions, such as skeptical opinions, sensational reactions, etc., towards fake news through online platforms, such as through social media posts. The emotions, opinions, reactions, expressions, etc. towards a news article are typically expressed in texts, and may be collectively referred to as comments in the present disclosure. A comment is associated with a news article (a piece of news). Textual information of a comment has been shown to be related to the content of original news pieces. Thus, comments may contain useful semantic information that has the potential to help fake news detection. In some embodiments, comments associated with a news article may be encoded to learn the latent representations of the comments. Comments extracted from social media may be short texts, and RNNs may be used to encode the word sequence in comments directly to learn the latent representations of the comments. Similar to the word encoder 210, bidirectional GRU may be adopted to model the word sequences in the comments. Specifically, given a comment cⱼ with words wₜ^{j}, t∈{1, . . . , Qⱼ}, we first map each word wₜ^{j} into a word vector wₜ^{j}∈ [symbol] ^{d} with an embedding matrix. Then, we may obtain the feedforward hidden states \vec{hₜ^{j}} and backward hidden states [symbol] for wₜ^{j} as follows:

\vec{hₜⁱ}=\vec{GRU}(wₜ^{j}),t∈{1, . . . ,Qᵢ}

[symbol]

= [symbol] (wₜ^{j}),t∈{Qᵢ, . . . ,1}. (5)

An annotation hₜ^{j} of word wₜ^{j} may be obtained by concatenating \vec{hₜ^{j}} and [symbol] i.e., hₜ^{j}= [symbol] . An attention mechanism is provided to learn weights to measure the importance of each word to the comment cⱼ. A comment vector c^{j}∈ [symbol] ^{2d×1} for the comment cⱼ may be computed as follows:

c^{j}=Σₜ₌₁^{Q}^{ⱼ}βₜ^{j}hₜ^{j}, (6)

where βₜ^{j} measures the importance of the t^{th} word for the comment cⱼ, and βₜ^{j} may be calculated as follows:

$${u}_{t}^{j} = tanh ( {W}_{c} {h}_{t}^{j} + {b}_{c} ) \\ {β}_{t}^{j} = \frac{exp ( {u}_{t}^{j} {u}_{c}^{T} )}{{\sum }_{k = 1}^{{Q}_{j}} exp ( {u}_{k}^{j} {u}_{c}^{T} )} , \qquad ( 7 )$$

where uₜ^{j} is a hidden representation of hₜ^{j}, which may be obtained by feeding the hidden state hₜ^{j} to a fully embedding layer, and u_{c} is a weight parameter. βₜ^{j} may also be referred to as an attention weight of the word wₜ^{j}, and indicates a level of importance of the word wₜ^{j} to the meaning of the comment cⱼ.

A comment vector c^{j} for each comment cⱼ may thus be obtained using equations (5)-(7). FIG. 2 shows an example using comment c₂ of T comments associated with the news article. As shown, the forward hidden state \vec{hₜ²} and the backward hidden state [symbol] of each word wₜ², t∈{1, . . . , Q₂} are obtained based on equation (5). Based on equations (6) and (7), the comment vector c² is then obtained for the comment c₂.

It has been observed that not all sentences in news contents may be fake, and in fact, many sentences are true but only for supporting wrong claim sentences. Thus, news sentences may not be equally important in determining and explaining whether a piece of news is fake or not. For example, the sentence “Michelle Obama is so vulgar she's not only being vocal.” is strongly related to the major fake claim “Pence: Michelle Obama Is The Most Vulgar First Lady We've Ever Had”, while “The First Lady denounced the Republican presidential nominee” is a sentence that expresses some fact and is less helpful in detecting and explaining whether the news is fake.

Similarly, user comments may contain relevant information about important aspects that explain why a piece of news is fake, while they may also be less informative and noisy. For example, a comment “Where did Pence say this? I saw him on CBS this morning and he didn't say these things.” is more explainable and useful to detect fake news, than other comments such as “Pence is absolutely right”.

Thus, we may aim to select some news sentences and user comments that can explain why a piece of news is fake. As they provide relatively good explanations, they should also be helpful in detecting fake news. An attention mechanism may be designed to give high weights to representations of news sentences and comments that are beneficial for fake news detection. In some embodiments, sentence-comment co-attention may be used to capture semantic affinity of sentences and comments, and further help learn attention weights of sentences and comments simultaneously.

According to some embodiments, we may construct a feature map (or feature matrix) S=[s¹; . . . , s^{N}]∈ [symbol] ^{2d×N} of the news sentences and a feature map (or feature matrix) C={c¹, . . . , c^{T}}∈ [symbol] ^{2d×T} of the user comments, and the co-attention attends to the sentences and comments simultaneously. An affinity matrix F∈ [symbol] ^{T×N} of the news sentences and the user comments may be computed as follows,

F=tan h(C^{T}WₗS), (8)

where Wₗ∈ [symbol] ^{2d×2d} is a weight matrix, which is to be learned through networks. tan h ( ) represents the hyperbolic tangent function. The affinity matrix F shows semantic correlation or relevance degree between each sentence and each comment. In other words, the affinity matrix F shows the semantic affinity or similarity between each sentence and each comment. The affinity matrix F may be considered as a feature and used to learn to predict a sentence attention map H^{S} and a comment attention map H^{c} as follows:

H^{s}=tan h(WₛS+(W_{c}C)F)

H^{c}=tan h(W_{c}C+(WₛS)F^{T})′ (9)

where Wₛ, W_{c}∈ [symbol] ^{k×2d} are weight parameters. An attention map may be a scalar matrix representing a relative importance of layer activations at different 2D spatial locations with respect to a target task. As an example, an attention map may be a grid of numbers that indicates which 2D locations are important for a task. The affinity matrix F transforms user comment attention space to news sentence attention space, and F^{T} transforms news sentence attention space to user comment attention space. The attention weights a^{s} of the N sentences and attention weights a^{c} of the T comments may be calculated, respectively, as follows;

a^{s}=softmax(wₕₛ^{T}H^{s})

a^{c}=softmax(w_{hc}^{T}H^{c})′ (10)

where a^{s}∈ [symbol] ^{1×N} and a^{c}∈ [symbol] ^{1×T} may also be referred to as attention probabilities of the N sentences s and the T comments cⱼ. wₕₛ, w_{hc}∈R^{1×k} are weight parameters. The attention weights of the sentences are calculated by taking into consideration of the correlation of the sentences with the comments, and the attention weights of the comments are calculated by taking into consideration of the correlation of the comments with the sentences. An attention weight of a sentence reflects a degree of explainability of the sentence in detecting a fake news article. An attention weight of a comment reflects a degree of explainability of the comment in detecting a fake news article. In some embodiments, the higher an attention weight is, the more explainable a sentence or comment is in terms of fake news detection, i.e., supporting or providing explanation for the fake news detection. Based on the attention weights in equation (10), a sentence attention vector ŝ may be calculated as a weighted sum of the sentence features, and a comment vector ĉ may be calculated as a weighted sum of the comment features, i.e.,

ŝ=Σᵢ₌₁^{N}aᵢ^{s}sⁱ,ĉ=Σⱼ₌₁^{T}aⱼ^{c}c^{j}, (11)

where ŝ∈ [symbol] ^{1×2d} and ĉ∈ [symbol] ^{1×2d} are the learned features for the news sentences and the user comments through co-attention.

Each sentence and each comment will participate in calculating the sentence attention map H^{s} and the comment attention map H^{c}, according to equation (9). Based on the sentence attention map H^{s}, an attention weight for each sentence is calculated according to equation (10). Based on the comment attention map H^{c}, an attention weight for each comment is calculated according to equation (10). The sentence attention vector ŝ and the comment vector ĉ are then calculated according to equation (11). FIG. 2 shows, as an example, that at the sentence-comment co-attention component 240, the sentence annotation s¹ and the comment vector c¹ participate in calculating the H^{s}, and the sentence annotation s^{N} and the comment vector c^{T} participate in calculating the H^{c}.

Whether the news article is fake or not may then be predicted according to the following embodiment objective:

ŷ=softmax([ŝ,ĉ]W_{f}+b_{f}), (12)

where ŷ=[ŷ₀, ŷ₁] is the predicted probability vector, with ŷ₀ and ŷ₁ indicate the predicted probability of label being 0 (real news) and 1 (fake news), respectively. y∈{0,1} denotes the ground truth label of news. [ŝ, ĉ] means the concatenation of learned features for news sentences and user comments. b_{f}∈ [symbol] ^{1×2} is a bias term. “softmax” represents the softmax function.

For each news piece, a goal may be to minimize a cross-entropy loss function as follows:

[symbol]

(θ)=−y log(ŷ₁)−(1−y)log(1−ŷ₀), (13)

where θ denotes parameters of a neural network. Equation (13) may be used to train the neural network based on the fake news prediction/detection result obtained from equation (12).

The parameters in the learning network may be learned through RMSprop, which is an adaptive learning rate method which divides the learning rate by an exponentially decaying average of squared gradients. RMSprop is a popular and effective method for determining the learning rate abortively, which is widely used for training neural networks.

FIG. 2 shows that the fake news prediction component 250 performs fake news prediction according to equation (12) and neural network training according to equation (13).

The framework may be modeled and implemented using a neural network, and used to detect whether a news article is fake with explanation, and to train the neural network for explainable fake news detection. The components 210-250 may be implemented in corresponding layers of the neural network, e.g., a word encoder layer, a sentence encoder layer, a comment encoder layer, a sentence-comment co-attention, and a fake news prediction layer. The neural network may receive a plurality of news articles as inputs, together with their associated comments, and predict/detect whether each news article is fake according to equations (1)-(12), and adjust parameters of the neural networks based on equation (13) to train the neural network.

The embodiment dEFEND framework may determine/detect whether a news article is fake, and provide a list of sentences of the news article and a list of comments associated with the news article as a general explanation of the determination/detection result. The list of sentences and the list of comments may provide explanation why the news article is fake or is real. The list of sentences may be selected from the N sentences of the news article, e.g., according to the attention weights of the n sentences. As an example, the list of sentences may include sentences that have attention weights greater than a sentence threshold. As another example, the sentences may be ordered/ranked in a descending order of the attention weights, and top-k1 sentences may be selected as the list of sentences. The list may be referred to as a rank list of sentences. The list of the comments may be selected from the T comments of the news article, e.g., according to the attention weights of the T comments. As an example, the list of comments may include comments that have attention weights greater than a comment threshold. As another example, the comments may be ordered/ranked in a descending order of the attention weights, and top-k2 comments may be selected as the list of comments (a rank list of comments). The sentence threshold and the comment threshold may be learned by training the neural network. The list of sentences may be those that include a content related to a major claim of the news, include the major claim of the news, and/or include information that is used for fake news detection, e.g., to support detection of fake news or real news, or to explain why the news is likely to be fake or not, in connection with one or more comments. The list of comments may be those that include information that is used for fake news detection, e.g., to explain why a content in a sentence is fake or not fake. The list of sentences may be referred to as explainable sentences of the news. The list of comments may be referred to as explainable comments of the news. In addition, a correspondence between a sentence of the list of sentences and one or more comments of the list of comments may be provided to show that the one or more comments are correlated with the sentence, and the one or more comments include information to explain that the sentence is fake or not.

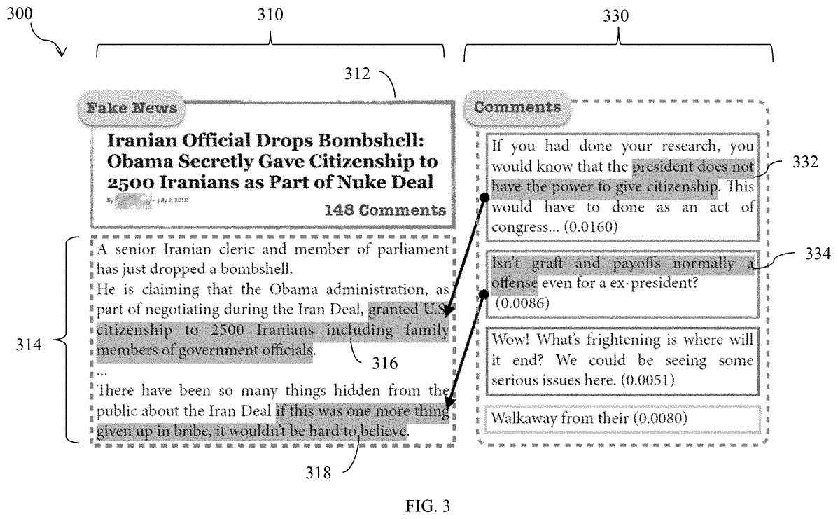

FIG. 3 is a diagram illustrating an embodiment explainable fake news detection result 300. The result 300 includes a piece of news 310 on PolitiFact that is detected and comments 330 associated with the news 310. The news 310 includes a headline 312 and a plurality of sentences 314. The news 310 is detected as fake news. The result 300 shows (by highlighting) a list of sentences 316, 318, and comments 332 and 334 for explanation of the detection result. FIG. 3 shows that the comments 332 and 334 are corresponding to the sentences 316, 318, respectively, and are explainable comments to the corresponding sentences for determining that the news 310 is fake. For example, the sentence 316 describes that Obama administration grant U.S. citizenship, while the comment 332 says that president does not have power to give citizenship. The comment 332 is captured by the embodiment framework to explain that the news may be fake.

Based on the fake news detection result of a news article, in one embodiment the news may be marked as fake or real. In another embodiment, the fake news may be saved in a fake news database, which may be used by users to verify a fake news article. In another embodiment, based on the fake news, another piece of news may be created and shared to indicate that the news is fake. The embodiment may be applied to various applications, and examples include:
Brand monitoring, digital market content protection, market trends/consumer interest authenticity.
Cybersecurity: Disinformation threats early detection, disinformation attribution identification.
Fraud and bot identification.
Health-related information authenticity checking
Financial news/knowledge authenticity checking, disinformation attribution for scandal investigation, monitoring disinformation manipulating stock market.
Defending national security from foreign influence, track online user opinions to offline public events on disinformation narratives, mitigating disinformation spread at the early stage in a national emergency event (e.g., COVID-19).
Education: Journalists training on disinformation dissemination, for example.

For example, a neural network implementing the embodiment method may be trained to monitor brand-related information to determine whether marking-related news is fake. In another example, people who disseminate news may be trained to detect whether news articles are fake before disseminating the news. In yet another example, social media platforms may monitor and filter out fake news by detecting the fake news using the embodiment method. The embodiments may be applied to detect news that includes one or more sentences and that has one or more associated comments.

Experiments have been performed to evaluate the performance of the embodiment dEFEND framework and method for explainable fake news detection. We utilize a fake news detection benchmark dataset called FakeNewsNet for simulations and evaluations. The dataset is collected from two platforms with fact-checking: GossipCop and PolitiFact, both including news content with labels and social context information. News content includes meta attributes of the news (e.g., body text), and social context includes the related user social engagements of news items (e.g., user comments in Twitter). Note that we keep news pieces with at least 3 comments. The detailed statistics of the datasets are shown in Table 1 below.

TABLE 1

| Platform | PolitiFact | GossipCop |
|---|---|---|
| # Users | 68,523 | 156,467 |
| # Comments | 89,999 | 231,269 |
| # Candidate news | 415 | 5,816 |
| # True news | 145 | 3,586 |
| # Fake news | 270 | 2,230 |

We compare the performance of the embodiment dEFEND method with some existing fake news detection algorithms listed as follows:
RST: RST stands for Rhetorical Structure Theory, which builds a tree structure to represent rhetorical relations among the words in the text. RST can extract news style features by mapping the frequencies of rhetorical relations to a vector space.
LIWC: LIWC stands for Linguistic Inquiry and Word Count, which is used to extract the lexicons falling into psycho-linguistic categories. It's based on a large set of words that represent psycho-linguistic processes, summary categories, and part-of-speech categories. It learns a feature vector from psychology and deception perspective.
HAN: HAN utilizes a hierarchical attention neural network framework on news contents for fake news detection. It encodes news contents with word-level attentions on each sentence and sentence-level attentions on each document.
text-CNN: text-CNN utilizes convolutional neural networks to model news contents, which captures different granularity of text features with multiple convolution filters.
TCNN-URG: TCNN-URG consists of two major components: a two-level convolutional neural network to learn representations from news content, and a conditional variational auto-encoder to capture features from user comments.
HPA-BLSTM: HPA-BLSTM is a neural network model that learns news representation through a hierarchical attention network on word-level, post-level, and sub-event level of user engagements on social media. In addition, post features are extracted to learn the attention weights during post-level.
CSI: CSI is a hybrid deep learning model that utilizes information from text, response, and source. The news representation is modeled via an LSTM neural network with the Doc2Vec embedding on the news contents and user comments as input, and for a fair comparison, the user features are ignored.

For feature extraction, different learning algorithms are used and the learning algorithm generating the best performance is chosen. The leaning algorithms used include Logistic Regression, Naive Bayes, Decision, Decision Tree, and Random Forest. We run these algorithms using scikit-learn with default parameter settings.

To evaluate the performance of the fake news detection algorithms, we use the following metrics, which are commonly used to evaluate classifiers in the art: Accuracy, Precision, Recall, and F1. Precision is a fraction of relevant instances among retrieved instances. Recall is a fraction of relevant instances that were retrieved. Precision and Recall are sometimes used together in an F₁ Score (or f-measure) to provide a single measurement for a system. Accuracy is a weighted arithmetic mean of Precision and Inverse Precision (weighted by Bias) as well as a weighted arithmetic mean of Recall and Inverse Recall (weighted by Prevalence. We randomly choose 75% of news pieces for training and remaining 25% for testing, and the process is performed for 5 times. The average performance is reported in Table 2 below.

TABLE 2

| | | | | text- | | TCNN- | HPA- | | |
|---|---|---|---|---|---|---|---|---|---|
| Datasets | Metric | RST | LIWC | CNN | HAN | URG | BLSTM | CSI | dEFEND |
| PolitiFact | Accuracy | 0.607 | 0.769 | 0.653 | 0.837 | 0.712 | 0.846 | 0.827 | 0.904 |
| | Precision | 0.625 | 0.843 | 0.678 | 0.824 | 0.711 | 0.894 | 0.847 | 0.902 |
| | Recall | 0.523 | 0.794 | 0.863 | 0.896 | 0.941 | 0.868 | 0.897 | 0.956 |
| | F1 | 0.569 | 0.818 | 0.760 | 0.860 | 0.810 | 0.881 | 0.871 | 0.928 |
| GossipCop | Accuracy | 0.531 | 0.736 | 0.739 | 0.742 | 0.736 | 0.753 | 0.772 | 0.808 |
| | Precision | 0.534 | 0.756 | 0.707 | 0.655 | 0.715 | 0.684 | 0.732 | 0.729 |
| | Recall | 0.492 | 0.461 | 0.477 | 0.689 | 0.521 | 0.662 | 0.638 | 0.782 |
| | F1 | 0.512 | 0.572 | 0.569 | 0.672 | 0.603 | 0.673 | 0.682 | 0.755 |

From the Table 2, we have the following observations:
For news content based methods RST, LIWC and HAN, we can see that HAN>LIWC>RST for both datasets. It indicates that 1) HAN can better capture the syntactic and semantic cues through hierarchical attention neural networks in news contents to differentiate fake and real news; 2) LIWC can better capture the linguistic features in news contents. The good results of LIWC demonstrate that fake news pieces are very different from real news in terms of choosing the words that reveal psychometrics characteristics.
In addition, methods using both news contents and user comments perform better than those methods purely based on news contents, and those methods only based on user comments, i.e., dEFEND>HAN or HPA−BLSTM and CSI>HAN or HPA−BLSTM. This indicates that features extracted from news content and corresponding user comments have complementary information, and thus boost the detection performance.
Moreover, the performances of user comment based methods are slightly better than news content based methods. For example, we have HPA−BLSTM>HAN in terms of Accuracy and F1 on both PolitiFact and GossipCop data. It shows that features extracted from user comments have more discriminative power than those only on news content for predicting fake news.
Generally, for methods based on both news content and user comments (i.e., dEFEND, CSI, and TCNN−URG), we can see that dEFEND consistently outperforms CSI and TCNN−URG and, i.e., dEFEND>CSI>TCNN−URG, in terms of all evaluation metrics on both datasets. For example, dEFEND achieves average relative improvement of 4.5%, 3.6% on PolitiFact and 4.7%, 10.7% on Gossipcop, comparing with CSI in terms of Accuracy and F1 score. It supports the importance of modeling co-attention of news sentences and user comments for fake news detection.

In some embodiments, the following three variants of dEFEND methods are defined, which may be used to analyze the effects of using news contents (sentences), comments and sentence-comment co-attention for fake news detection.
dEFEND\C: dEFEND\C is a variant of dEFEND without considering information from user comments. It first encodes news contents with word-level attentions on each sentence, and then the resultant sentence features are averaged through an average pooling layer and fed into a softmax layer for classification.
dEFEND\N: dEFEND\N is a variant of dEFEND without considering information from news contents. It first utilizes the comment encoder to learn comment features, and then the resultant comment features are averaged through an average pooling layer and fed into a softmax layer for classification.
dEFEND\Co: dEFEND\Co is a variant of dEFEND, which eliminates the sentence-comment co-attention. Instead, it performs self-attention on sentences and comments separately and the resultant features are concatenated to a dense layer and fed into a softmax layer for classification.

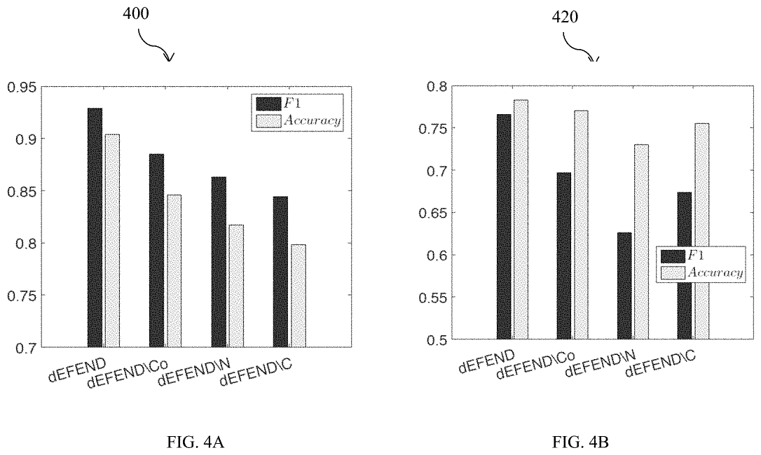

The parameters in the above three variants and dEFEND are determined with cross-validation and the best performance of each variant is used for analysis. FIGS. 4A and 4B are graphs 400 and 420 showing performance of three variants and dEFEND in fake news detection using metrics F1 and Accuracy. FIG. 4A shows the performance obtained based on the dataset collected from PolitiFact. FIG. 4B shows the performance obtained based on the dataset collected from GossipCop. We have the following observations from FIGS. 4A and 4B:
When we eliminate the co-attention for news contents and user comments, the performances are reduced. It suggests the importance of modeling the correlation and captures the mutual influence between news contents and user comments.
When we eliminate the effect of news contents component, the performance of dEFEND\N degrades in comparison with dEFEND. For example, the performance reduces 4.2% and 6.6% in terms of F1 and Accuracy metrics on PolitiFact, 18.2% and 6.8% on GossipCop. The results suggest that news contents in dEFEND are important.
We have a similar observation for dEFEND\C when eliminating the effect of user comments. The results suggest the importance to consider the feature of user comments to guide fake news detection in dEFEND.

It can be seen that both components of news contents and user comments contribute to the improved performance on fake news detection using dEFEND. It would be desirable and beneficial to model both news contents and user comments for fake news detection. The news contents and user comments contain complementary information that is useful for determining whether a news article is fake.

In the following, we evaluate the performance of explainability of the dEFEND framework from the perspective of news sentences and user comments. It is worth mentioning that all of the existing fake news detection algorithms discussed above are designed for fake news detection, while none of them are initially proposed to discover explainable news sentences or user comments. To measure the performance of dEFEND for explainability, we choose HAN for comparison of news sentence explainability, and HPA-BLSTM as the baselines for user comments explainability. Both HAN and HPA-BLSTM can learn attention weights for news sentences and user comments, respectively. Note that HAN uses the attention mechanism to learn the document structure, while HPA-BLSTM utilizes the attention mechanism to learn the temporal structure of comments. Since there is no temporal structure in documents, HAN cannot be used in comments; Similarly, since there are no document structure in comments, HPA-BLSTM cannot be directly applied to news contents.

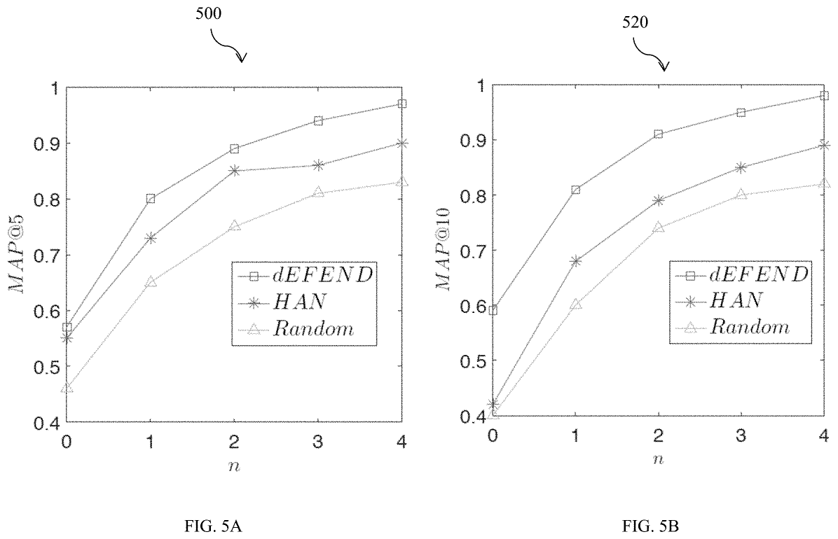

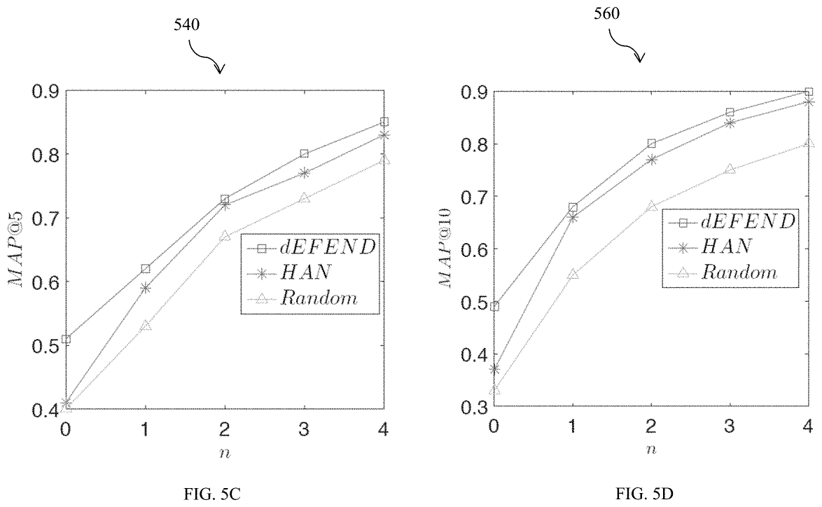

As described above, a rank list of news sentences and a rank list of comments may be selected for explanation of a fake news detection result. We may evaluate the performance of explainability of the rank list (RS) of news sentences. Specifically, the evaluation may show the top-ranked explainable sentences determined by dEFEND are more likely to be related to the major claims in the fake news that are worth to check (check-worthy). We utilize ClaimBuster to obtain a ground truth rank list [symbol] of all check-worthy sentences in a piece of news content. ClaimBuster proposes a scoring model that utilizes various linguistics features trained using tens of thousands of sentences from past general election debates that were labeled by human coders, and gives a “check-worthiness” score between 0 and 1. The higher the score, the more likely the sentence contains check-worthy factual claims. The lower the score, the more non-factual, subjective and opinionated the sentence is. We compare top-k rank list of the explainable sentences in news contents by dEFEND (RS⁽¹⁾) and HAN (RS⁽²⁾), with top-k rank list [symbol] by ClaimBuster, using the evaluation metric, MAP@k (Mean Average Precision), where k is set as 5 and 10. We also introduce another parameter n (referred to as a neighborhood threshold) which controls a window size that allows n neighboring sentences to be considered when comparing the sentences in RS⁽¹⁾ and RS⁽²⁾, with each of the top-k sentences in [symbol] . The simulation results are shown in FIGS. 5A-5D. FIG. 5A is a graph 500 showing simulation performance MAP@5 of selecting/determining the top-ranked explainable sentences, varying with the neighborhood threshold. FIG. 5B is a graph 520 showing simulation performance MAP@10 of selecting/determining the top-ranked explainable sentences. FIGS. 5A and 5B show the respective performances obtained by using dEFEND, HAN and randomly selected sentences (indicated as “Random”), and using the dataset from PolitiFact. FIGS. 5C and 5D are graphs 540 and 560 showing respective simulation performances MAP@5 and MAP@10, using the dataset from GossipCop. We have the following observations based on FIGS. 5A-5D:
In general, we can see that dEFEND>HAN>Random for the performance of finding check-worthy sentences in news contents on both datasets. It indicates that the sentence-comment co-attention component in dEFEND can help selecting more check-worthy sentences.
With the increase of n, we relax the condition to match check-worthy sentences in the ground truth, and thus the MAP performance is increasing.
When n=1, the performance of dEFEND on MAP@5 and MAP@10 increases to exceed 0.8 for PolitiFact, which indicates that dEFEND can detect check-worthy sentences well within 1 neighboring sentence of the ground truth sentences in [symbol] .

We may also evaluate the performance of the explainability of the rank list of comments selected by dEFEND. We deploy several tasks (i.e., Task 1 and Task 2) using Amazon Mechanical Turk (AMT) to evaluate the explainability rank list of the comments RC for fake news. We perform the following settings to deploy AMT tasks for a total of 50 fake news pieces. For each news article, we first filter out very short articles with less than 50 words. In addition, for very long articles with more than 500 words in content, we presented only the first 500 words to reduce the amount of reading for workers. As the first 3-4 paragraphs of news articles often summarize the content, the first 500 words are usually sufficient to capture the gist of the articles. Then, we recruited AMT workers located in the U.S. (who are more likely to be familiar with the topics of the articles) with the approval rate >0.95. To evaluate the explainability of user comments, for each news article, we have two lists of top-k comments, L⁽¹⁾=(L₁⁽¹⁾, L₂⁽¹⁾, . . . , Lₖ⁽¹⁾) for using dEFEND and L⁽²⁾=(L₁⁽²⁾, L₂⁽²⁾, . . . , Lₖ⁽²⁾) for HPA-BLSTM. The top-k comments are selected and ranked using the attention weights from high to low. To evaluate the model ability to select topmost explainable comments, we empirically set k=5. We deploy two AMT tasks to evaluate the explainable ranking performance.

For Task 1, we perform list-wise comparison. We ask workers to pick a collectively better list between L⁽¹⁾ and L⁽²⁾. To remove the position bias, we randomly assign the positions, top and bottom, of L⁽¹⁾ and L⁽²⁾ when presented to workers. We let each worker pick the better list between L⁽¹⁾ and L⁽²⁾ for each news piece. Each news piece is evaluated by 3 workers, and finally 150 results of workers' choices are obtained. In a worker-level, we compute the number of workers that choose L⁽¹⁾ and L⁽²⁾, and also compute the winning ratio (WR for short) for them. In a news-level, we perform majority voting for all 3 workers for each news, and decide if workers choose L⁽¹⁾ or L⁽²⁾. For each news, we also compute the worker-level choices by computing a ratio between L⁽¹⁾ and L⁽²⁾. Based on Task 1, we have the following observations:
dEFEND can select better top-k explainable comments than HPA-BLSTM both in worker-level and news-level. For example, in worker-level, 98 out of 150 workers (with WR=0.65) choose L⁽¹⁾ over L⁽²⁾. In news-level, dEFEND has better performance in 32 out of 50 news pieces (with WR=0.64) than HPA-BLSTM.
There are more news pieces such that 3 workers vote unanimously for L⁽¹⁾ (3 vs 0) than the opposite case (0 vs 3) for their explainability. Similarly, there are more cases where 2 workers vote for dEFEND than HPA-BLSTM.

For Task 2, we perform item-wise evaluation. For each comment in L⁽¹⁾ and L⁽²⁾, we ask workers to choose a score from {0,1,2,3,4}, where 0 means “not explainable at all,” 1 means “not explainable,” 3 means “somewhat explainable,” 4 means “highly explainable,” and 2 means “somewhere in between.” To avoid the bias caused by different user criteria, we shuffle the order of comments in L⁽¹⁾ and L⁽²⁾, and ask workers to assess how explainable each comment is with respect to the news. To estimate rank-aware explainability of comments (i.e., having a higher ranked explainable comment is more desirable than a lower ranked one), we use NDCG (Normalized Cumulative Gain) and Precision@k as the evaluation metrics. NDCG is widely used in information retrieval to measure document ranking performance in search engines. It can measure how good a ranking is by comparing the proposed ranking with the ideal ranking list measured by user feedback. Precision@k is a proportion of recommended items in a top-k set that are relevant. Similarly, each news piece is evaluated by 3 workers, and a total of 750 results of workers' ratings are obtained for each method. News articles are sorted by the discrepancy in the metrics between the two methods in descending order. In the simulation, k=5. Based on Task 2, we have the following observations:
Among 50 fake news articles, dEFEND obtains higher NDCG scores than HPA-BLSRM for 38 cases in terms of the item-wise evaluation. Overall mean NDCG scores over 50 cases for dEFEND and HPA-BLSRM are 0.71 and 0.55, respectively.
Similar results can be found on Precision@5. dEFEND is superior to HPA-BLSTM on 35 fake news articles and tied on 7 articles. Overall mean Precision@5 scores over 50 cases for dEFEND and HPA-BLSRM are 0.67 and 0.51, respectively.

The simulation shows that some explainable comments that correctly found/elected and ranked high by dEFEND are missed by HPA-BLSTM. FIG. 3 shows an example rank list of comments determined in the simulation, with an attention weight provided for each comment at the end of each comment in parenthesis. Based on the simulation results, dEFEND can rank more explainable comments higher than non-explainable comments. Taking FIG. 3 as an example, the comment 332 “ . . . president does not have the power to give citizenship . . . ” is ranked at the top with an attention weight 0.016, which can explain exactly why the sentence 316 “granted U.S. citizenship to 2500 Iranians including family members of government officials” in the news content is fake. Higher weights may be given to explainable comments than those interfering and unrelated comments, which can help select more related comments and detect fake news. For example, unrelated comment “Walkaway from their . . . ” has an attention weight 0.0080, which is less than an explainable comment “Isn't graft and payoffs normally a offense” with an attention weight 0.0086. The latter comment may be selected to be a more important feature for fake news prediction.

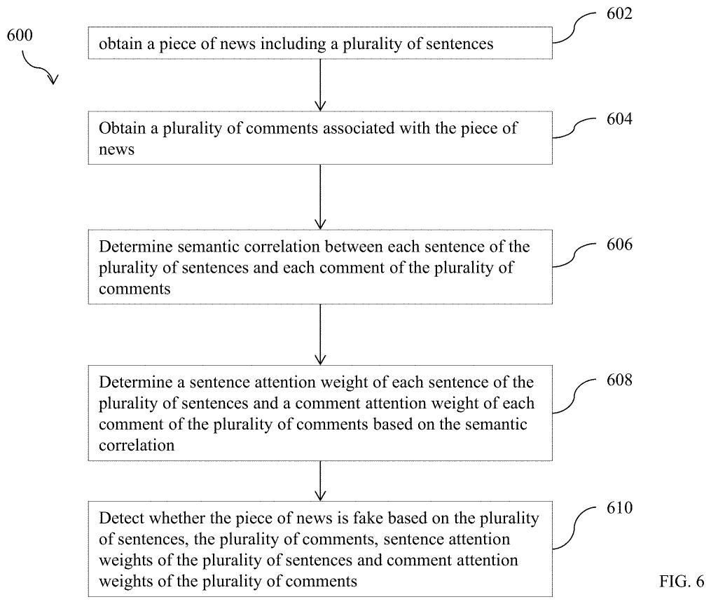

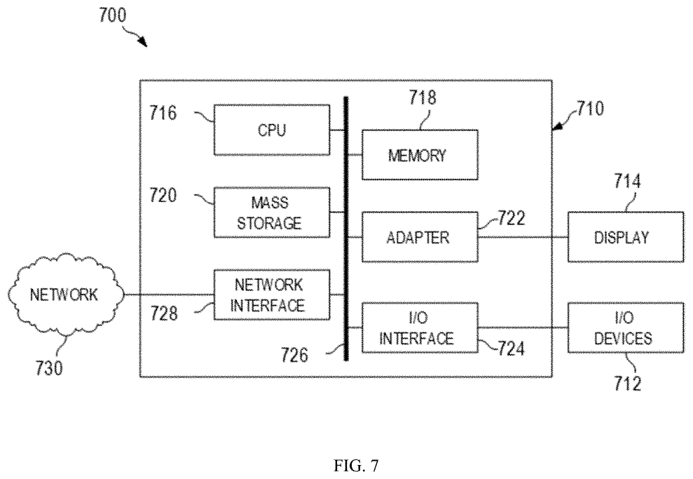

FIG. 6 is a diagram of an embodiment method 600 for explainable fake news detection. Method 600 may be a computer-implemented method, and performed using a processing system as shown in FIG. 7. As shown, the method 600 may include obtaining a piece of news including a plurality of sentences (block 602). The method 600 may include obtaining a plurality of comments associated with the piece of news (block 604). The method 600 may further include determining semantic correlation between each sentence of the plurality of sentences and each comment of the plurality of comments (block 606). This may be performed based on latent representations of the plurality of sentences and latent representations of the plurality of comments. This may generate respective correlation degrees between the plurality of sentences and the plurality of comments. The method 600 may also include determining a sentence attention weight of each sentence of the plurality of sentences and a comment attention weight of each comment of the plurality of comments based on the semantic correlation (block 608). This may be performed based on the respective correlation degrees, the latent representations of the plurality of sentences and the latent representations of the plurality of comments. The method 600 may include detecting whether the piece of news is fake based on the plurality of sentences, the plurality of comments, sentence attention weights of the plurality of sentences and comment attention weights of the plurality of comments (block 610). For example, detecting whether the piece of news is fake may be performed based on the latent representations of the plurality of sentences weighted by respective sentence attention weights and based on the latent representations of the plurality of comments weighted by respective comment attention weights.

FIG. 7 is a block diagram of a processing system 700 that may be used for implementing the systems and methods disclosed herein. Specific devices may utilize all of the components shown, or only a subset of the components, and levels of integration may vary from device to device. Furthermore, a device may contain multiple instances of a component, such as multiple processing units, processors, memories, interfaces, adapters, etc. The processing system 700 may comprise a processing unit 710. The processing unit 710 may include a central processing unit (CPU) 716, memory 718, a mass storage device 720, an adapter 722 (may include a video adapter and/or an audio adapter), a network interface 728, and an I/O interface 724, some or all of which may be coupled to a bus 726. The I/O interface 724 is coupled to one or more input/output (I/O) devices 712, such as a speaker, microphone, mouse, touchscreen, keypad, keyboard, camera, display 714, and the like. The adapter 722 is coupled to a display 714 in the example shown.

The bus 726 may be one or more of any type of several bus architectures including a memory bus or memory controller, a peripheral bus, video bus, or the like. The CPU 716 may comprise any type of electronic data processor. The memory 718 may comprise any type of non-transitory system memory such as static random access memory (SRAM), dynamic random access memory (DRAM), synchronous DRAM (SDRAM), read-only memory (ROM), a combination thereof, or the like. In an embodiment, the memory 718 may include ROM for use at boot-up, and DRAM for program and data storage for use while executing programs.

The mass storage device 720 may comprise any type of non-transitory storage device configured to store data, programs, and other information and to make the data, programs, and other information accessible via the bus. The mass storage device 720 may comprise, for example, one or more of a solid state drive, hard disk drive, a magnetic disk drive, an optical disk drive, or the like.

The adapter 722 and the I/O interface 724 provide interfaces to couple external input and output devices to the processing unit 710. As illustrated, examples of input and output devices include the display 714 coupled to the adapter 722, and the speaker/microphone/mouse/keyboard/camera/buttons/keypad 712 coupled to the I/O interface 724. Other devices may be coupled to the processing unit 710, and additional or fewer interface cards may be utilized. For example, a serial interface such as Universal Serial Bus (USB) (not shown) may be used to provide an interface for a camera.

The processing unit 710 also includes one or more network interfaces 728, which may comprise wired links, such as an Ethernet cable or the like, and/or wireless links to access nodes or different networks 730. The network interface 728 allows the processing unit 710 to communicate with remote units via the networks 730, such as a video conferencing network. For example, the network interface 728 may provide wireless communication via one or more transmitters/transmit antennas and one or more receivers/receive antennas. In an embodiment, the processing unit 710 is coupled to a local-area network (LAN) or a wide-area network (WAN) for data processing and communications with remote devices, such as other processing units, the Internet, remote storage facilities, or the like.

While the present application is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution described in the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute embodiments of the methods disclosed herein.

Please also refer to an Appendix to the specification titled “dEFEND: Explainable Fake News Detection”, which is herein incorporated by reference in its entirety, for further description of the present disclosure.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A computer-implemented method comprising:
obtaining a piece of news comprising a plurality of sentences;
obtaining a plurality of comments associated with the piece of news;
determining semantic correlation between each sentence of the plurality of sentences and each comment of the plurality of comments based on latent representations of the plurality of sentences and latent representations of the plurality of comments, to generate respective correlation degrees between the plurality of sentences and the plurality of comments;
determining a sentence attention weight of each sentence of the plurality of sentences and a comment attention weight of each comment of the plurality of comments, based on the respective correlation degrees, the latent representations of the plurality of sentences and the latent representations of the plurality of comments; and
detecting whether the piece of news is fake based on the latent representations of the plurality of sentences weighted by respective sentence attention weights and based on the latent representations of the plurality of comments weighted by respective comment attention weights.

2. The method of claim 1, further comprising:
generating a detection result indicating whether the piece of news is fake, the detection result comprising a list of sentences selected from the plurality of sentences and comprising a list of comments selected from the plurality of comments, wherein each sentence of the list of sentences has a sentence attention weight greater than a sentence threshold, and each comment of the list of comments has a comment attention weight greater than a comment threshold.

3. The method of claim 2, wherein the detection result further indicates a correspondence between a sentence of the list of sentences and a comment of the list of comments, the comment comprising an explanation feature corresponding to the sentence.

4. The method of claim 2, further comprising:
ranking the list of sentences on a degree of explainability for detecting whether the piece of news is fake; and
ranking the list of comments on a degree of explainability for detecting whether the piece of news is fake.

5. The method of claim 2, further comprising:
sorting the plurality of sentences in a descending order of the respective sentence attention weights; and
sorting the plurality of comments in a descending order of the respective comment attention weights;
selecting top-k1 sentences from the plurality of sentences as the list of sentences; and
selecting top-k2 comments from the plurality of comments as the list of comments,
wherein k1 and k2 are integers greater than 0.

6. The method of claim 1, further comprising:
generating the latent representations of the plurality of sentences and the latent representations of the plurality of comments, respectively, using a recurrent neural network based word encoder with bidirectional gated recurrent units (GRUs).

7. The method of claim 1, wherein the correlation degrees are calculated as:
F=tan h(C^{T}WₗS),
wherein F is an affinity matrix with each matrix element representing a correlation degree, C represent the latent representations of the plurality of sentences, S represent the latent representations of the plurality of comments, Wₗ∈ [symbol] ^{2d×2d} is a weight matrix, C^{T} represent transpose of C, tan h ( ) represents the hyperbolic tangent function.

8. The method of claim 7, wherein the respective sentence attention weights and the respective comment attention weights are calculated as:
a^{s}=softmax(wₕₛ^{T}H^{s})
a^{c}=softmax(w_{hc}^{T}H^{c})′
wherein a^{s}∈ [symbol] ^{1×N} represents the respective sentence attention weights and a^{c}∈ [symbol] ^{1×T} represents the respective comment attention weights, N is an integer representing a quantity of the plurality of sentences, T is an integer representing a quantity of the plurality of comments, wₕₛ, w_{hc}∈ [symbol] ^{1×k} are weight parameters, softmax ( ) is the softmax function, and
H^{s}=tan h(WₛS+(W_{c}C)F)
H^{c}=tan h(W_{c}C+(WₛS)F^{T})′
wherein Wₛ, W_{c}∈ [symbol] ^{k×2d} are weight parameters.

9. The method of claim 1, wherein the method is performed using a learning neural network, and the method further comprise:
training the learning neural network using a detection result of detecting whether the piece of news is fake.

10. A device comprising:
a non-transitory memory storage comprising instructions; and
one or more processors in communication with the memory storage, wherein the instructions, when executed by the one or more processors, cause the device to perform:
obtaining a piece of news comprising a plurality of sentences;
obtaining a plurality of comments associated with the piece of news;
determining semantic correlation between each sentence of the plurality of sentences and each comment of the plurality of comments based on latent representations of the plurality of sentences and latent representations of the plurality of comments, to generate respective correlation degrees between the plurality of sentences and the plurality of comments;
determining a sentence attention weight of each sentence of the plurality of sentences and a comment attention weight of each comment of the plurality of comments, based on the respective correlation degrees, the latent representations of the plurality of sentences and the latent representations of the plurality of comments; and
detecting whether the piece of news is fake based on the latent representations of the plurality of sentences weighted by respective sentence attention weights and the latent representations of the plurality of comments weighted by respective comment attention weight.

11. The device of claim 10, wherein the instructions, when executed by the one or more processors, cause the device further to perform:
generating a detection result indicating whether the piece of news is fake, the detection result comprising a list of sentences selected from the plurality of sentences and comprising a list of comments selected from the plurality of comments, wherein each sentence of the list of sentences has a sentence attention weight greater than a sentence threshold, and each comment of the list of comments has a comment attention weight greater than a comment threshold.

12. The device of claim 11, wherein the detection result further indicates a correspondence between a sentence of the list of sentences and a comment of the list of comments, the comment comprising an explanation feature corresponding to the sentence.

13. The device of claim 11, wherein the instructions, when executed by the one or more processors, cause the device further to perform:
ranking the list of sentences on a degree of explainability for detecting whether the piece of news is fake; and
ranking the list of comments on a degree of explainability for detecting whether the piece of news is fake.

14. The device of claim 11, wherein the instructions, when executed by the one or more processors, cause the device further to perform:
sorting the plurality of sentences in a descending order of the respective sentence attention weights; and
sorting the plurality of comments in a descending order of the respective comment attention weights;
selecting top-k1 sentences from the plurality of sentences as the list of sentences; and
selecting top-k2 comments from the plurality of comments as the list of comments, wherein k1 and k2 are integers greater than 0.

15. The device of claim 10, wherein the instructions, when executed by the one or more processors, cause the device further to perform:
generating the latent representations of the plurality of sentences and the latent representations of the plurality of comments, respectively, using a recurrent neural network based word encoder with bidirectional gated recurrent units (GRUs).

16. The device of claim 10, wherein the correlation degrees are calculated as:
F=tan h(C^{T}WₗS),
wherein F is an affinity matrix with each matrix element representing a correlation degree, C represent the latent representations of the plurality of sentences, S represent the latent representations of the plurality of comments, Wₗ∈ [symbol] ^{2d×2d} is a weight matrix, C^{T} represent transpose of C, tan h ( ) represents the hyperbolic tangent function.

17. The device of claim 16, wherein the respective sentence attention weights and the respective comment attention weights are calculated as:
a^{s}=softmax(wₕₛ^{T}H^{s})
a^{c}=softmax(w_{hc}^{T}H^{c})′
wherein a^{s}∈ [symbol] ^{1×N} represents the respective sentence attention weights and a^{c}∈ [symbol] ^{1×T} represents the respective comment attention weights, N is an integer representing a quantity of the plurality of sentences, T is an integer representing a quantity of the plurality of comments, wₕₛ, w_{hc}∈ [symbol] ^{1×k} are weight parameters, softmax ( ) is the softmax function, and
H^{s}=tan h(WₛS+(W_{c}C)F)
H^{c}=tan h(W_{c}C+(WₛS)F^{T})′
wherein Wₛ, W_{c}∈ [symbol] ^{k×2d} are weight parameters.

18. The device of claim 10, wherein the instructions, when executed by the one or more processors, cause the device further to perform:
training a learning neural network using a detection result of detecting whether the piece of news is fake, the learning neural network configured for fake news detection.

19. A non-transitory computer-readable media storing computer instructions, that when executed by one or more processors of a device, cause the device to perform:
obtaining a piece of news comprising a plurality of sentences;
obtaining a plurality of comments associated with the piece of news;
determining semantic correlation between each sentence of the plurality of sentences and each comment of the plurality of comments based on latent representations of the plurality of sentences and the latent representations of the plurality of comments, to generate respective correlation degrees between the plurality of sentences and the plurality of comments;
determining a sentence attention weight of each sentence of the plurality of sentences and a comment attention weight of each comment of the plurality of comments, based on the respective correlation degrees, the latent representations of the plurality of sentences and the latent representations of the plurality of comments; and
detecting whether the piece of news is fake based on the latent representations of the plurality of sentences weighted by respective sentence attention weights and the latent representations of the plurality of comments weighted by respective comment attention weight.

20. The non-transitory computer-readable media of claim 19, wherein the computer instructions, when executed by the one or more processors, cause the device further to perform:
generating a detection result indicating whether the piece of news is fake, the detection result comprising a list of sentences selected from the plurality of sentences and comprising a list of comments selected from the plurality of comments, wherein each sentence of the list of sentences has a sentence attention weight greater than a sentence threshold, and each comment of the list of comments has a comment attention weight greater than a comment threshold.
